(19) United States
(12) Patent Application Publication
(10) Pub. No.: US 2004/0193620 A1
(43) Pub. Date: Sep. 30, 2004

(54) Association caching

(75) Inventors: Cheng-Chieh Cheng, Rochester, MN (US); Mercer L. Colby, Rochester, MN (US); Eric N. Herness, Rochester, MN (US)

Correspondence Address: Robert R. Williams, IBM Corporation, Dept. 917, 3605 Highway 52 North, Rochester, MN, 55901-7829, US

(73) Assignee: International Business Machines Corporation, Armonk, NY

(21) Appl. No.: 10/403,155

(22) Filed: Mar. 31, 2003

(51) Int. Cl. G06F 7/00

(52) U.S. Cl. 707/100

(57) ABSTRACT

A method, apparatus, system, and signal-bearing medium that in an embodiment find a relationship between data in data caches and update an association cache with the relationship asynchronously from updates to the data caches. In an embodiment, a relationship occurs when a foreign key in a data cache matches a primary key in another data cache. The association cache may include information about the relationship, which in an embodiment may include an owner key and a list of one or more owned keys.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

1. Field

This invention relates generally to the caching of data in an association cache.

2. Background

A computer system stores data in its memory. In order to do useful work, the computer system operates on and performs manipulations against this data. Ideally, a computer system would have a singular, indefinitely large and very fast memory, in which any particular data would be immediately available to the computer system. In practice this has not been possible because memory that is very fast is also very expensive.

Thus, computers typically have a hierarchy (or levels) of memory, each level of which has greater capacity than the preceding level but which is also slower with a less expensive per-unit cost. These levels of the hierarchy may form a subset of one another, that is, all data in one level may also be found in the level below, and all data in that lower level may be found in the one below it, and so on until we reach the bottom of the hierarchy. In order to minimize the performance penalty that the hierarchical memory structure introduces, it is desirable to store the most-frequently-used data in the fastest memory and the least-frequently-used data in the slowest memory.

For example, a computer system might contain:

1) a very small, very fast, and very expensive cache that contains the most-frequently-used data;

2) a small, fast, and moderately expensive RAM (Random Access Memory) that contains all the data in the cache plus the next most-frequently-used data; and

3) several large, slow, inexpensive disk drives that contain all the data in the computer system.

When the computer system needs a piece of data, it looks first in the cache. If the data is not in the cache, the computer system retrieves the data from a lower level of memory, such as RAM or a disk drive, and places the data in the cache. If the cache is already full of data, the computer system must determine which data to remove from the cache in order to make room for the data currently needed.

The algorithm used to select which data is moved back through the levels of storage is called the replacement algorithm. The goal of the replacement algorithm is to predict which data will be accessed frequently and keep that data in the high-speed cache ready for immediate access while migrating less-used data through the storage hierarchy toward the slower levels.

The storage hierarchy becomes more complicated when one computer, often called a client, accesses data in a storage device on another computer, often called a server. Accessing data on a remote server is time consuming when compared to accessing data on storage connected locally because requests for data must travel across a network and be processed by the remote server. Thus, reducing the number of requests for data from the server is highly desirable.

One technique for accessing data on a remote server is defined by the EJB (Enterprise Java Beans) specification, which describes a system of persistent objects. Some vendors have implemented an extension to EJB under which some objects are held in the cache beyond the scope of the unit of work under which they were fetched from the server, thus reducing the number of requests from the client to the server. The EJB specification has a notion of container-managed relationships, in which not only the attributes of the object are to be persistent in the cache, but relationships or associations between objects as well. A way to handle persistent relationships is with an association cache used in conjunction with a data cache. An association cache stores the relationships or associations between the data in the data cache.

The problem is that the association cache is typically only updated when container-managed accessors are executed, whereas the data cache is updated on every query from the client to the server. This results in the execution of a potentially large number of redundant queries to the server, which impacts performance. For example, consider a scenario where ObjectA and ObjectB are invoked in a one-to-one relationship, both ObjectA and ObjectB are retrieved using a find by primary key operation, and both objects are configured with a lifetime-in-cache attribute. When ObjectA attempts to retrieve ObjectB, another copy of ObjectB will be retrieved from the server even though ObjectB is in the cache since the association between ObjectA and ObjectB has not been cached.

What is needed is a technique for keeping the association cache updated. Although the problem has been described in terms of Enterprise Java Beans and persistent objects, the problem applies equally to any technique for caching data that has relationships.

### SUMMARY

A method, apparatus, system, and signal-bearing medium are provided that in an embodiment find a relationship between data in data caches and update an association cache with the relationship asynchronously from updates to the data caches. In an embodiment, a relationship occurs when a foreign key in a data cache matches a primary key in another data cache. The association cache may include information about the relationship, which in an embodiment may include an owner key and a list of one or more owned keys.

### BRIEF DESCRIPTION OF THE DRAWINGS

FIG. 1 depicts a block diagram of an example system for implementing an embodiment of the invention.

FIG. 2 depicts a block diagram of an example cache data structure, according to an embodiment of the invention.

FIG. 3A depicts a block diagram of example data in the cache data structure before operation of a cache synchronizer, according to an embodiment of the invention.

FIG. 3B depicts a block diagram of example data in the cache data structure before operation of the cache synchronizer, according to an embodiment of the invention.

FIG. 4A depicts a block diagram of example data in the cache data structure after operation of the cache synchronizer, according to an embodiment of the invention.

FIG. 4B depicts a block diagram of example data in the cache data structure after operation of the cache synchronizer, according to an embodiment of the invention.

FIG. 5 depicts a flowchart of example processing for the cache synchronizer, according to an embodiment of the invention.

FIG. 6 depicts a flowchart of example processing for the process foreign keys function in the cache synchronizer, according to an embodiment of the invention.

FIG. 7 depicts a flowchart of example processing for the association cache, according to an embodiment of the invention.

FIG. 8 depicts a flowchart of example processing for the association cache of a related data cache, according to an embodiment of the invention.

### DETAILED DESCRIPTION

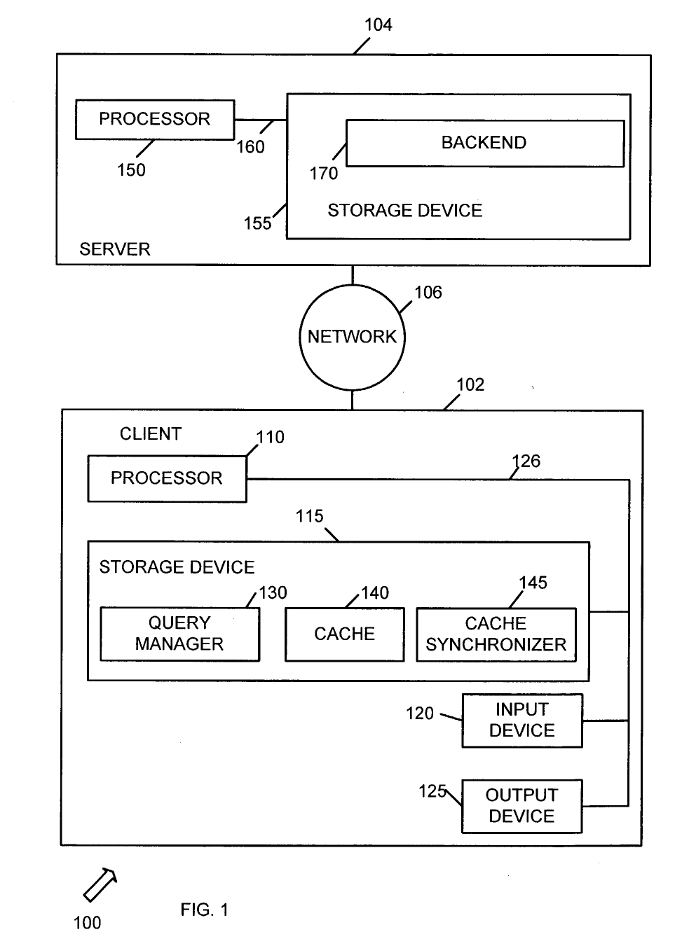

FIG. 1 depicts a block diagram of an example system 100 for implementing an embodiment of the invention. The system 100 includes a client 102 connected to a server 104 via a network 106. Although only one client 102, one server 104, and one network 106 are shown, in other embodiments any number or combination of them may be present.

The client 102 includes a processor 110, a storage device 115, an input device 120, and an output device 125, all connected via a bus 126. The processor 110 represents a central processing unit of any type of architecture, such as a CISC (Complex Instruction Set Computing), RISC (Reduced Instruction Set Computing), VLIW (Very Long Instruction Word), or a hybrid architecture, although in other embodiments any appropriate processor may be used. The processor 110 executes instructions and includes that portion of the client 102 that controls the operation of the entire client. Although not depicted in FIG. 1, the processor 110 typically includes a control unit that organizes data and program storage in memory and transfers data and other information between the various parts of the client 102. The processor 110 reads and/or stores code and data to/from the storage device 115, the input device 120, the output device 125, and/or the server 104 via the network 106.

Although the client 102 is shown to contain only a single processor 110 and a single bus 126, embodiments of the present invention apply equally to electronic devices that may have multiple processors and multiple buses with some or all performing different functions in different ways.

The storage device 115 represents one or more mechanisms for storing data. For example, the storage device 115 may include read only memory (ROM), random access memory (RAM), magnetic disk storage media, optical storage media, flash memory devices, and/or other machine-readable media. In other embodiments, any appropriate type of storage device may be used. Although only one storage device 115 is shown, multiple storage devices and multiple types of storage devices may be present. Further, although the client 102 is drawn to contain the storage device 115, it may be distributed across other electronic devices, e.g., electronic devices connected to the network 106. The storage device 115 includes a query manager 130, a cache 140, and a cache synchronizer 145.

The query manager 130 retrieves data from the server 104 and places the data in the cache 140, as further described below.

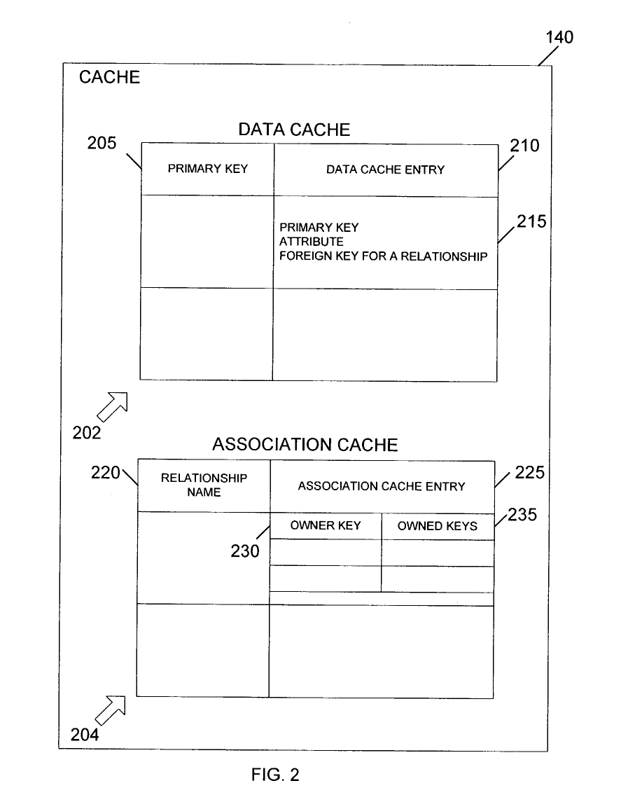

The cache 140 includes a data cache and an association cache, which describes the relationships between the data in the data cache. The cache 140 is further described below with reference to FIGS. 2, 3a, 3b, 4a, and 4b.

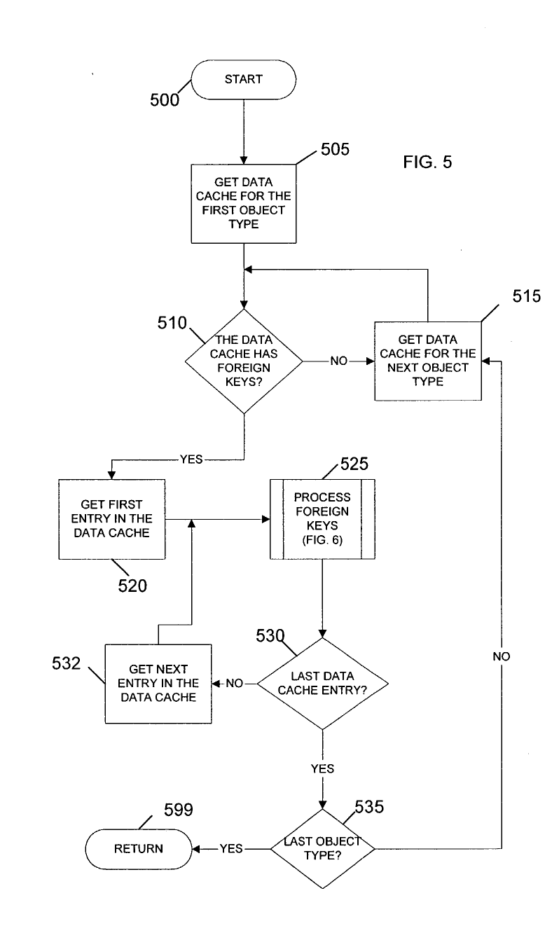

The cache synchronizer 145 synchronizes the association cache with the data cache. In an embodiment, the cache synchronizer 145 includes instructions capable of being executed on the processor 110 or statements capable of being interpreted by instructions executing on the processor 110. In another embodiment, the cache synchronizer 145 may be implemented via hardware in lieu of or in addition to a processor-based system. The functions of the cache synchronizer 145 are further described below with reference to FIGS. 5, 6, 7, and 8.

The input device 120 may be a keyboard, mouse or other pointing device, trackball, touchpad, touchscreen, keypad, microphone, voice recognition device, or any other appropriate mechanism for the user to input data to the client 102. Although only one input device 120 is shown, in another embodiments any number (including zero) and type of input devices may be present.

The output device 125 presents output to a user. The output device 125 may be a cathode-ray tube (CRT) based video display well known in the art of computer hardware. But, in other embodiments the output device 125 may be replaced with a liquid crystal display (LCD) based or gas, plasma-based, flat-panel display. In another embodiment, the output device 125 may be a speaker. In another embodiment, the output device 125 may be a printer. In still other embodiments, any appropriate output device may be used. Although only one output device 125 is shown, in other embodiments, any number of output devices (including zero) of different types or of the same type may be present.

The bus 126 may represent one or more busses, e.g., PCI (Peripheral Component Interconnection), ISA (Industry Standard Architecture), X-Bus, EISA (Extended Industry Standard Architecture), or any other appropriate bus and/or bridge (also called a bus controller).

The server 104 includes a processor 150 and a storage device 155 connected via a bus 160. The processor 150, the storage device 155, and the bus 160 may be analogous to the description for the processor 110, the storage device 115, and the bus 126 previously described above.

The storage device 155 includes a backend 170. In an embodiment, the backend 170 is a database, but in other embodiments, the backend 170 may be any type of data repository. The server 104 sends data from the backend 170 to the client 102 in response to queries from the query manager 130.

The client 102 and the server 104 may be implemented using any suitable hardware and/or software, such as a personal computer or other electronic device. Portable computers, laptop or notebook computers, PDAs (Personal Digital Assistants), pocket computers, telephones, pagers, automobiles, teleconferencing systems, appliances, and mainframe computers are examples of other possible configurations of the client 102 and/or the server 104. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

The network 106 may be any suitable network or combination of networks and may support any appropriate protocol suitable for communication between the client 102 and the server 104. In various embodiments, the network 106 may represent a storage device or a combination of storage devices, either connected directly or indirectly to the client 102 and/or the server 104. In another embodiment, the network 106 may support Infiniband. In an embodiment, the network 106 may support wireless communications. In another embodiment, the network 106 may support hard-wired communications, such as a telephone line or cable. In another embodiment, the network 106 may support the Ethernet IEEE (Institute of Electrical and Electronics Engineers) 802.3x specification. In another embodiment, the network 106 may be the Internet and may support EP (Internet Protocol). In another embodiment, the network 106 may be a local area network (LAN) or a wide area network (WAN). In another embodiment, the network 106 may be a hotspot service provider network. In another embodiment, the network 106 may be an intranet. In another embodiment, the network 106 may be a GPRS (General Packet Radio Service) network. In another embodiment, the network 106 may be any appropriate cellular data network or cell-based radio network technology. In another embodiment, the network 106 may be an IEEE 802.11B wireless network. In still another embodiment, the network 106 may be any suitable network or combination of networks. Although one network 106 is shown, in other embodiments any number of networks (of the same or different types) may be present.

As will be described in detail below, aspects of an embodiment of the invention pertain to specific apparatus and method elements implementable on a client, computer, or other electronic device. In another embodiment, the invention may be implemented as a program product for use with a client, computer, or other electronic device. The programs defining the functions of this embodiment may be delivered to the client, computer, or other electronic device via a variety of signal-bearing media, which include, but are not limited to:

(1) information permanently stored on a non-rewriteable storage medium, e.g., a read-only memory device attached to or within a client, computer, or electronic device, such as a CD-ROM readable by a CD-ROM drive;

(2) alterable information stored on a rewriteable storage medium, e.g., a hard disk drive or diskette; or

(3) information conveyed to a client, computer, or other electronic device by a communications medium, such as through a computer or a telephone network, including wireless communications.

Such signal-bearing media, when carrying machine-readable instructions that direct the functions of the present invention, represent embodiments of the present invention.

FIG. 2 depicts a block diagram of an example cache data structure 140, according to an embodiment of the invention. The cache 140 includes a data cache 202 and an association cache 204. The association cache 204 is associated with the data cache 202. The data cache 202 is for an object, which is an entity about which data may be stored and/or retrieved to/from the backend 170 (FIG. 1).

The data cache 202 includes a primary key field 205 and a data cache entry field 210. The data cache entry field 210 may include a primary key, an attribute for the type of the object, and a foreign key for a relationship between objects. In other embodiments, the attribute and/or the foreign key are optional.

A primary key of a relational table uniquely identifies each record in the table. The attribute is also known as a field or column. A foreign key is a field in a relational table that matches the primary key of another table. In an embodiment, the foreign key may be used to cross-reference tables in a relational database. A table in a relational database is a format of rows and columns that define an object in the database. A row is a set of attributes. An object is an entity about which data can be stored and is the subject of the table.

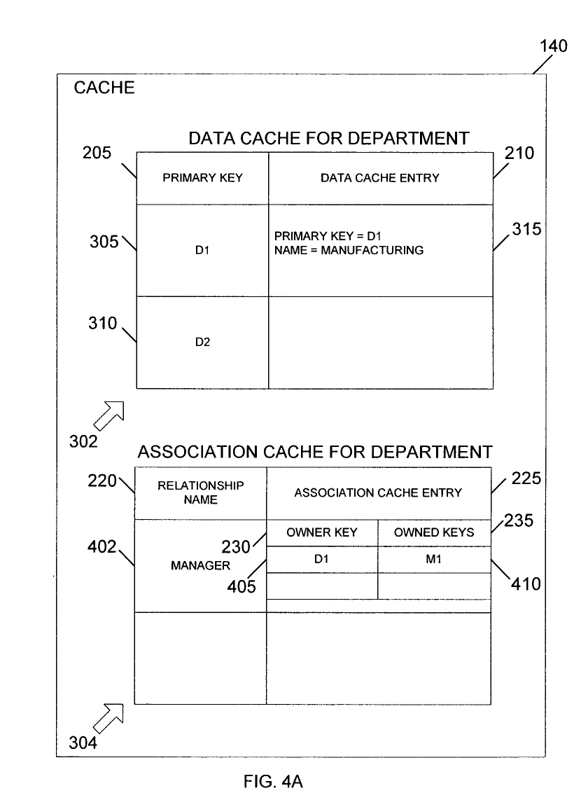

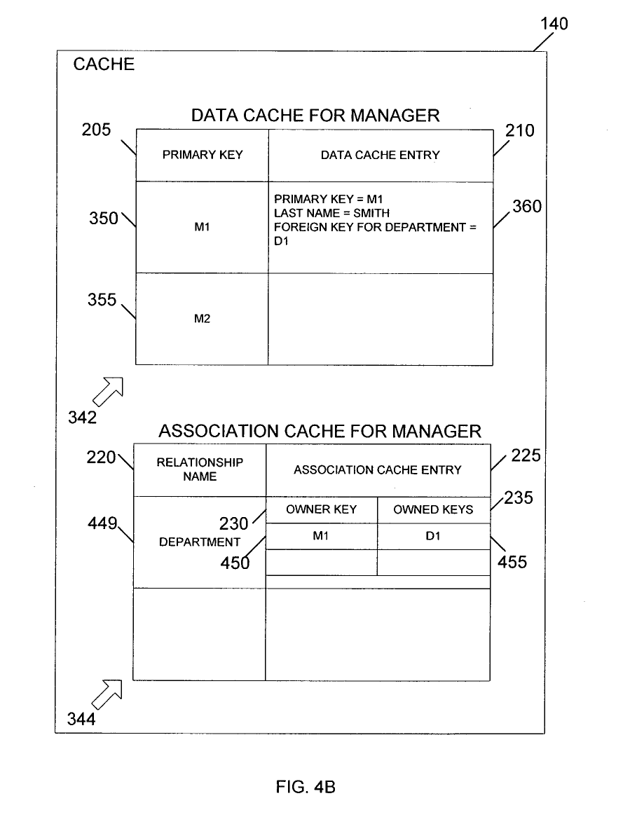

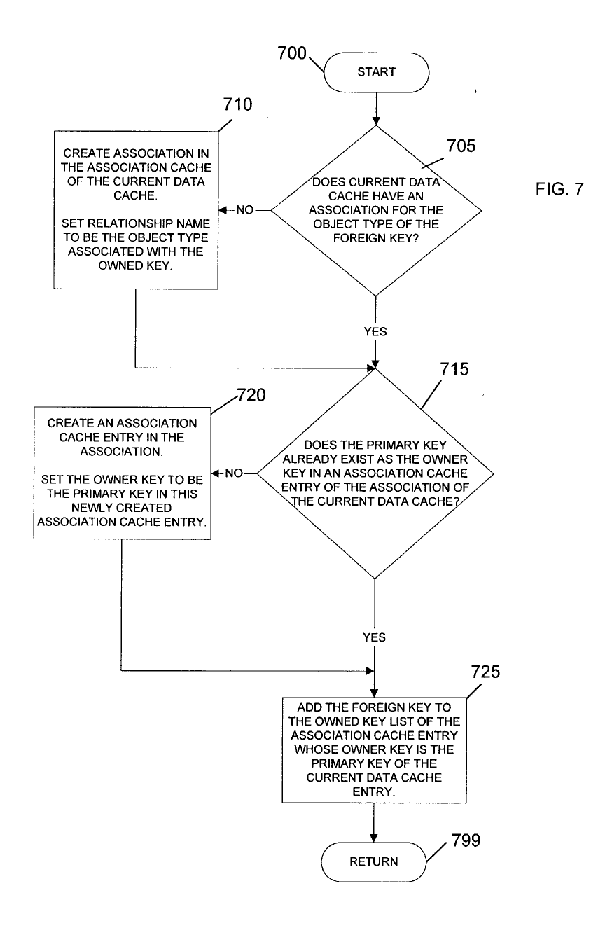

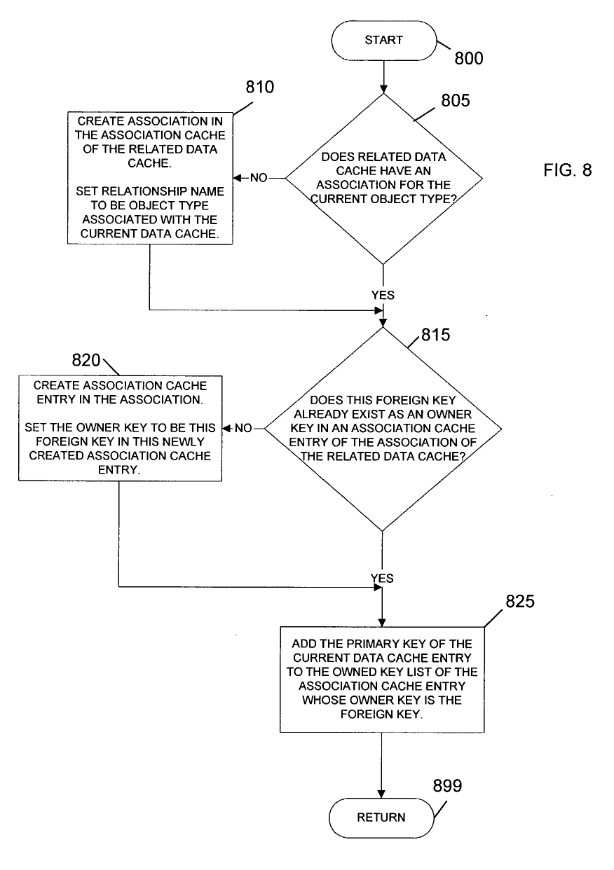

The association cache 204 includes a relationship name field 220 and an association cache entry field 225. The association cache entry field 225 includes an owner key field 230 and an owned keys field 235. The owner key 230 and the owned keys 235 describe the relationship between objects. Examples of entries in the owner key field 230 and the owned key field 235 are further described below with reference to FIGS. 4A and 4B. The setting of the owner key 230 and the owned key 235 by the cache synchronizer 145 is further described below with reference to FIGS. 7 and 8.

Although only one data cache 202 and one association cache 204 are shown, in other embodiments multiple data caches and multiple association caches may be present in the cache 140. For example, in an embodiment one data cache and one association cache exist for each object in the cache 140. Although the data cache 202 and the association cache 204 are drawn as separate data structures, in another embodiment, the data cache 202 and the association cache 204 may be part of the same data structure.

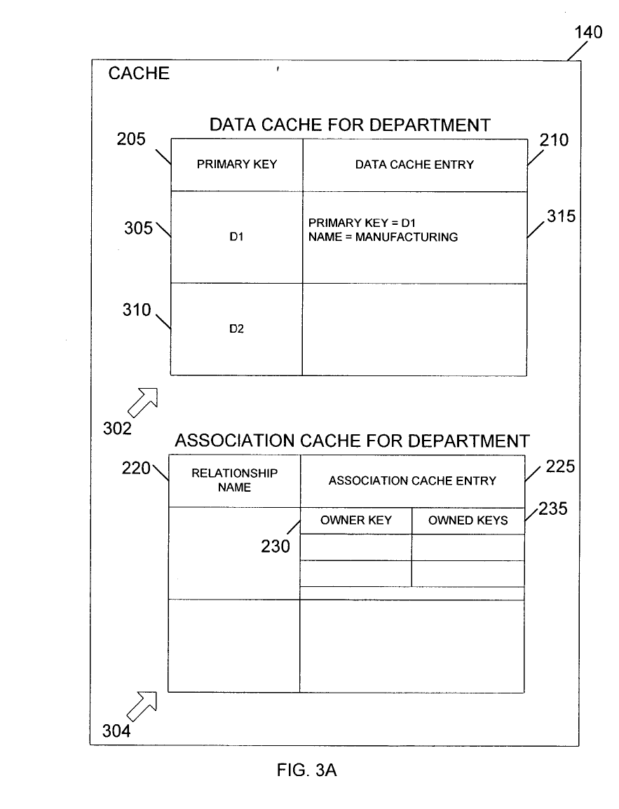

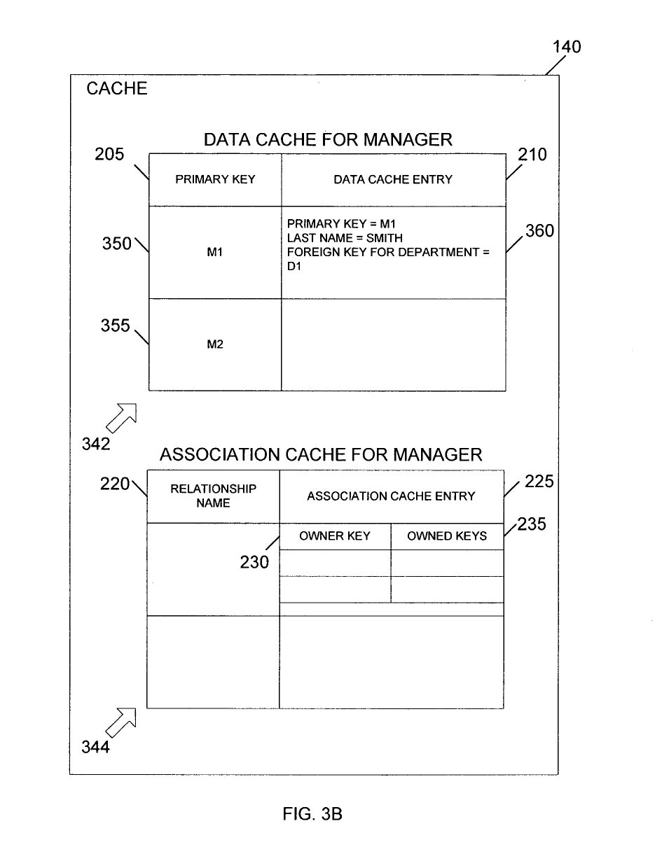

FIG. 3A depicts a block diagram of example data in the data cache 302 before operation of the cache synchronizer 145, according to an embodiment of the invention. In the example shown, the query manager 130 retrieved data associated with a department object from the back end 170 and placed the data in the primary key field 205 as D1 305 and D2 310 and into the data cache entry field 210 as entry 315 (primary key=D1 and name=manufacturing). Thus, in this example, the attribute of the department object is the name of the department, which is manufacturing, and the primary key for the manufacturing department object is D1. The data shown in FIG. 3A is exemplary only, and in other embodiments any appropriate data may be present.

Since the cache synchronizer 145 has not yet executed at the time associated with FIG. 3A, the association cache 304 for the department object does not yet contain entries in the relationship name field 220, the owner key field 230 in the association cache entry field 225, and the owned keys field 235 in the association cache entry field 225.

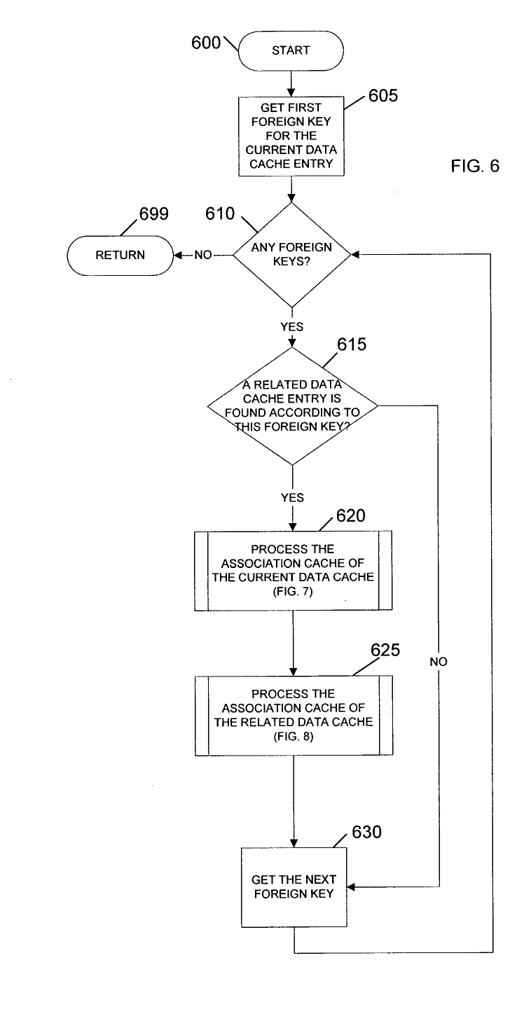

FIG. 3B depicts a block diagram of example data in the data cache 342 in the cache 140 before operation of the cache synchronizer 145, according to an embodiment of the invention. In the example shown, the query manager 130 retrieved data associated with a manager object from the back end 170 and placed the data in the primary key field 205 as M1 350 and M2 355 and into the data cache entry field 210 as entry 360 (primary key=M1, last name=Smith, and foreign key for department=D1). Thus, in this example, the attribute of the manager object is the last name of the manager of the department (whose foreign key is D1), which is Smith, the primary key for the manager object is M1, and the foreign key for the manager object is D1. Notice that in the example the foreign key for the manager object (D1) is the same as the primary key for the department object D1 305 in FIG. 3A. The cache synchronizer 145 uses this matching of the foreign key to the primary key to find a relationship, as further described below with reference to FIGS. 6, 7, and 8. The data shown in FIG. 3B is exemplary only, and in other embodiments any appropriate data may be present.

Since the cache synchronizer 145 has not yet executed at the time associated with FIG. 3B, the association cache 344 for the manager object does not yet contain entries in the relationship name field 220, the owner key field 230 in the association cache entry field 225, and the owned keys field 235 in the association cache entry field 225.

FIG. 4A depicts a block diagram of example data in the cache data structure 140 after operation of the cache synchronizer 145, according to an embodiment of the invention. At the time of FIG. 4A, the cache synchronizer 145 has examined the cache 140 and found a relationship between entries in the data cache 342 (FIG. 3B) for the manager object and the data cache 302 for the department object. The cache synchronizer 145 has placed the relationship associated with the data cache 302 for the department object in the association cache 304 for the department object. The data cache 302 for the department object is the same in FIG. 4A as it was in FIG. 3A. The association cache 304 for the department object now contains manager 402 in the relationship name field 220, D1 405 in the owner key field 230, and M1 410 in the owned keys field 235. Manager 402 is the object type associated with the owned key M1 410.

FIG. 4B depicts a block diagram of example data in the cache data structure 140 after operation of the cache synchronizer 145, according to an embodiment of the invention. At the time of FIG. 4B, the cache synchronizer 145 has examined the cache 140 and found a relationship between entries in the data cache 342 for the manager object and the data cache 302 (FIG. 3A) for the department object. The cache synchronizer 145 has placed the relationship associated with the data cache 342 for the manager object in the association cache 344 for the manager object. The data cache 342 for the manager object is the same in FIG. 4B as it was in FIG. 3B. The association cache 344 for the manager object now contains department 449 in the relationship name field 220, M1 450 in the owner key field 230, and D1 455 in the owned keys field 235. Department 449 is the object type associated with the owned key D1 455.

FIG. 5 depicts a flowchart of example processing for the cache synchronizer 145, according to an embodiment of the invention. In an embodiment, the cache synchronizer 145 executes asynchronously to the query manager 130 and is periodically invoked to examine the data cache 202 or caches and determine whether an entry in the data cache 202 belongs to an association, in which case the cache synchronizer 145 creates an association entry in the appropriate association cache 204, as further described below.

Control begins at block 500. Control then continues to block 505 where the cache synchronizer 145 finds a first data cache in the cache 140 associated with a first object type. Control then continues to block 510 where the cache synchronizer 145 determines whether the current data cache includes a foreign key or keys.

If the determination at block 510 is false, then control continues to block 515 where the cache synchronizer 145 gets the next data cache for the next object type. Control then returns to block 510, as previously described above.

If the determination at block 510 is true, then control continues to block 520 where the cache synchronizer 145 gets the first entry in the current data cache. Control then continues to block 525 where the cache synchronizer 145 processes the foreign key or keys and creates an entry or entries in the association cache, as further described below with reference to FIGS. 6, 7, and 8. Control then continues to block 530 where the cache synchronizer 145 determines whether the last data cache entry in the current data cache has been processed.

If the determination at block 530 is false, then control continues to block 532 where the cache synchronizer 145 gets the next entry in the current data cache. Control then returns to block 525, as previously described above.

If the determination at block 530 is true, then control continues to block 535 where the cache synchronizer 145 determines whether the last object type in the cache 140 has been processed. If the determination at block 535 is false, then control returns to block 515, as previously described above. If the determination at block 535 is true, then control continues to block 599 where the function returns.

FIG. 6 depicts a flowchart of example processing for the process foreign keys function in the cache synchronizer 145, according to an embodiment of the invention. Control begins at block 600. Control then continues to block 605 where the cache synchronizer 145 finds the first foreign key associated with the current data cache entry. Control then continues to block 610 where the cache synchronizer 145 determines whether any foreign keys exist for this data cache entry.

If the determination at block 610 is false, then control continues to block 699 where the function returns.

If the determination at block 610 is true, then control continues to block 615 where the cache synchronizer 145 searches all other data caches for other objects and determines whether a related data cache entry having a primary key is found that matches the foreign key in the current data cache entry. For example, using the data shown in FIGS. 3A, 3B, 4A, and 4B, entry 360 (FIG. 3B) has the foreign key D1, which matches the primary key D1 in entry 315 (FIG. 3A).

If the determination at block 615 is true, then control continues to block 620 where the cache synchronizer 145 processes the association cache of the current data cache, as further described below with reference to FIG. 7. Control then continues to block 625 where the cache synchronizer 145 processes the association cache of the related data cache, as further described below with reference to FIG. 8. Control then continues to block 630 where the cache synchronizer 145 gets the next foreign key. Control then returns to block 610, as previously described above.

If the determination at block 615 is false, then control continues directly from block 615 to block 630 where the cache synchronizer 145 gets the next foreign key. Control then returns to block 610, as previously described above.

FIG. 7 depicts a flowchart of example processing for the association cache, according to an embodiment of the invention. Control begins at block 700. Control then continues to block 705 where the cache synchronizer 145 determines whether the current data cache has an association for the object type of the foreign key. If the determination at block 705 is false, then control continues to block 710 where the cache controller 145 creates an association in the association cache of the current data cache and sets the relationship name to be the object type associated with the owned key.

Control then continues to block 715 where the cache controller 145 determines whether the primary key already exists as the owner key in an association cache entry of the association of the current data cache. If the determination at block 715 is false, then control continues to block 720 where the cache controller 145 creates an association cache entry in the association and sets the owner key to be the primary key in this newly-created association cache entry. Control then continues to block 725 where the cache controller 145 adds the foreign key to the owned key list of the association cache entry whose owner key is the primary key of the current data cache entry. Control then continues to block 799 where the function returns.

If the determination at block 705 is true, then control continues directly from block 705 to block 715, as previously described above.

If the determination at block 715 is true, then control continues directly from block 715 to block 725, as previously described above.

FIG. 8 depicts a flowchart of example processing for the association cache of a related data cache, according to an embodiment of the invention. Control begins at block 800. Control then continues to block 805 where the cache synchronizer 145 determines whether the related data cache has an association for the current object type. If the determination at block 805 is false, then control continues to block 810 where the cache synchronizer 145 creates an association in the association cache of the related data cache and sets the relationship name to be the object type associated with the current data cache.

Control then continues to block 815 where the cache synchronizer 145 determines whether the foreign key already exists as an owner key in an association cache entry of the association of the related data cache. If the determination at block 815 is false, then control continues to block 820 where the cache synchronizer 145 creates an association cache entry in the association and sets the owner key to be this foreign key in this newly-created association cache entry.

Control then continues to block 825 where the cache synchronizer 145 adds the primary key of the current data cache entry to the owned key list of the association cache entry whose owner key is the foreign key. Control then continues to block 899 where the function returns.

If the determination at block 805 is true, then control continues directly from block 805 to block 815, as previously described above.

If the determination at block 815 is true, then control continues directly from block 815 to block 825, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. But, the invention may be practiced without these specific details. In other instances, well-known circuits, structures, and techniques have not been shown in detail in order not to obscure the invention.

What is claimed is:

1. A method comprising:
finding a relationship between data in a plurality of data caches; and
updating a plurality of association caches with the relationship asynchronously from updates to the plurality of data caches.

2. The method of claim 1, wherein the finding further comprises:
finding a foreign key in a first data cache of the plurality of data caches.

3. The method of claim 2, wherein the finding further comprises:
finding a second data cache of the plurality of data caches, wherein the second data cache comprises a primary key that matches the foreign key.

4. The method of claim 3, wherein the updating further comprises:
setting an owned key in a first association cache of the plurality of association caches to be the foreign key, wherein the first association cache is associated with the first data cache.

5. The method of claim 3, wherein the updating further comprises:
adding a primary key of the first data cache to an owned key list of a second association cache of the plurality of association caches, wherein the second association cache is associated with the second data cache.

6. The method of claim 1, wherein the plurality of data caches and the plurality of association caches comprise a plurality of entries in a single cache.

7. The method of claim 1, wherein the plurality of data caches and the plurality of association caches comprise separate entities.

8. An apparatus comprising:
means for finding a foreign key in a first data cache;
means for finding a primary key in a second data cache, wherein the primary key that matches the foreign key; and
means for setting an owned key in a first association cache to be the foreign key, wherein the first association cache is associated with the first data cache.

9. The apparatus of claim 8, further comprising:
means for adding a primary key of the first data cache to an owned key list of a second association cache, wherein the second association cache is associated with the second data cache.

10. The apparatus of claim 8, further comprising:
means for setting a relationship name in the first association cache to be an object type associated with the owned key.

11. The apparatus of claim 8, wherein the first and second data caches are associated with respective first and second object types.

12. The apparatus of claim 11, further comprising:
means for retrieving data associated with the first and second object types into the first and second data caches asynchronously from the means for finding the foreign key, the means for finding the primary key, and the means for setting the owned key.

13. A signal-bearing medium encoded with instructions, wherein the instructions when executed comprise:
finding a relationship between first and second data caches; and
updating first and second association caches with the relationship asynchronously from updates to the first and second data caches, wherein the first association cache is associated with the first data cache, and the second association cache is associated with the second data cache.

14. The signal-bearing medium of claim 13, wherein the finding further comprises:
finding a foreign key in the first data cache.

15. The signal-bearing medium of claim 14, wherein the finding further comprises:
finding a primary key in the second data cache, wherein the primary key matches the foreign key.

16. The signal-bearing medium of claim 14, wherein the updating further comprises:
setting an owned key in the first association cache to be the foreign key.

17. The signal-bearing medium of claim 13, wherein the updating further comprises:
adding a primary key of the first data cache to an owned key list of the second association cache.

18. A signal-bearing medium encoded with a data structure accessed by a synchronizer that is to be executed by a processor, wherein the data structure comprises:
a data cache for an object, wherein the data cache comprises a primary key and a foreign key; and
an association cache associated with the data cache, wherein the association cache comprises a owner key and at least one owned key, wherein the synchronizer updates the association cache asynchronously from updates to the data cache.

19. The signal-bearing medium of claim 18, wherein the data cache further comprises an attribute for the object.

20. The signal-bearing medium of claim 18, wherein the synchronizer sets the owner key to be the primary key and adds the foreign key to the at least one owned key.

21. The signal-bearing medium of claim 18, wherein association cache further comprises a relationship name, and wherein the synchronizer sets the relationship name to be a name of an object associated with the foreign key.

22. An electronic device comprising:
a processor; and
a storage device encoded within instructions, wherein the instructions when executed on the processor comprise:
finding a foreign key in a first data cache,
finding a primary key in the second data cache, wherein the primary key matches the foreign key, and
updating first and second association caches with the relationship asynchronously from updates to the first and second data caches, wherein the first association cache is associated with the first data cache, and the second association cache is associated with the second data cache.

23. The electronic device of claim 22, wherein the updating further comprises:
setting an owned key in the first association cache to be the foreign key.

24. The electronic device of claim 22, wherein the updating further comprises:
adding a primary key of the first data cache to an owned key list of the second association cache.
